(19) United States
(12) Patent Application Publication
(10) Pub. No.: US 2012/0056779 A1
(43) Pub. Date: Mar. 8, 2012

(54) Method and Apparatus for Determination of a Doppler Frequency Shift Resulting from the Doppler Effect

(75) Inventor: Benno FREKING, Weyhe-Leeste (DE)

(73) Assignee: Atlas Elektronik GmbH, Bremen (DE)

(21) Appl. No.: 13/227,267

(22) Filed: Sep. 7, 2011

(30) Foreign Application Priority Data
Sep. 8, 2010 (DE) 10 2010 044 742.0

(51) Int. Cl. G01S 13/00

(52) U.S. Cl. 342/189; 342/196

(57) ABSTRACT

A method and apparatus for determination of a Doppler frequency shift 30 between a transmitted signal 4 and a received signal 20 resulting from this transmitted signal. A plurality of relative frequency shifts are carried out, in each case by a real frequency shift value, in that either at least one shifted discrete amplitude spectrum 8 of the transmitted signal 4 and at least one shifted discrete amplitude spectrum 22 of the received signal 20, or a plurality of shifted amplitude spectra of the transmitted signal 4 or of the received signal 20 are produced. Quality measures are determined for these frequency shifts, indicating the quality of the match between the shifted signals. That quality measure which corresponds to the highest quality of the match is determined, and the frequency shift value associated with this quality measure is equated to the Doppler frequency shift 30 to be determined.

### CROSS-REFERENCE TO RELATED APPLICATION

The present application claims the priority of German Patent Application No. 10 2010 044 742.0, filed Sep. 8, 2010, the subject matter of which, in its entirety, is incorporated herein by reference.

### BACKGROUND OF THE INVENTION

The invention relates to a method for determination of a Doppler frequency shift, resulting from the Doppler effect, between a transmitted signal and a received signal which results from this transmitted signal, to a method according to the precharacterizing clause of Claim 12, and to a computer program which has suitable program code means for carrying out the method.

Conventionally, a Doppler frequency shift is determined from the difference between a frequency of the transmitted signal and a frequency to be determined in the received signal by means of known methods, such as sonar methods and radar methods, which use the Doppler effect. The determination is in this case carried out predominately by correlation of spectra from the transmitted signal and the received signal, as disclosed, for example, in TW 1241788B, or by direct pattern comparison, for example as disclosed in DE 10 2008 029 352 A1. This Doppler frequency shift is normally used to determine the velocity between an object which transmits the transmitted signal and receives the received signal, and a further object, which is at a distance from the former and reflects the transmitted signal. In order to achieve a sufficiently accurate measurement result for the velocity, very long signals are required. However, the transmitted signals cannot be made indefinitely long, in order to avoid overlaps between the transmitted and received signals. In particular, this makes it more difficult to determine the Doppler frequency shift in calm water areas and when using Doppler sonar on board submarines or AUVs, which are often very close to the seabed.

U.S. Pat. No. 4,176,351 discloses a method for determination of a Doppler frequency shift, in which a “continuous wave” (CW) radar is used for velocity determination. For this purpose, the radar received signal is supplied to a plurality of bandpass filters, and, after filtering, that received signal is selected from the plurality of filtered received signals which has most energy after the filtering process. A possible Doppler frequency shift is therefore determined for each bandpass filter, from the difference between the known frequency of the transmitted signal and a mid-frequency associated with the bandpass filter.

However, this known method has the disadvantage that the accuracy for determination of the Doppler frequency shift by means of the mid-frequencies of the bandpass filters is restricted. Furthermore, a method such as this has the disadvantage that the value range of a Doppler frequency shift to be expected is dependent on the number of bandpass filters used for filtering the received signal.

WO2004/005945 A1 discloses a method for estimation of a frequency of a signal, for example of a “continuous wave” (CW) signal. In this known method, the signal is first of all transformed by means of fast Fourier transformation, referred to in the following text as FFT. One coefficient of the FFT is then determined, specifically that coefficient which has the maximum magnitude. In this way, the frequency to be determined of the signal corresponds to the frequency associated with this coefficient. Alternatively, the accuracy of the frequency to be determined is increased by means of modified discrete Fourier transformation, referred to in the following text as DFT, by varying the coefficients of the DFT.

This known method has the disadvantage that the FFT and the subsequent DFT determine the maximum coefficients relating to only one frequency in the signal. However, because the signal is noisy, this frequency could lead to an incorrectly determined frequency, if the maximum coefficient were not associated with the exact frequency of the signal, but with an adjacent frequency. The use of this method to determine the Doppler frequency shift would likewise be incorrect, because of the incorrectly determined frequency of the received signal.

DE 196 08 331 C2 describes an apparatus for measurement of a frequency of a discrete received signal, as well as use of this apparatus for measurement of a velocity of watercraft. This known apparatus has a shift register, which is designed to produce a clipped signal from the received signal, and to read this as a unit pulse. Furthermore, it has means which are designed to determine a frequency of the read unit pulse that is already occupying each bit location in the shift register, and for determining the frequency of the discrete received signal from this frequency. A Doppler frequency shift, by means of which a velocity can be determined, is then determined from the determined frequency of the received signal.

This known method has the disadvantage that the accuracy of the determined frequency depends on a bit location corresponding to the predetermined frequency, by virtue of the number of unit pulses amplified from the signal and thus clipped, and their frequency.

GB 2437619A discloses a measurement device for measurement of a Doppler frequency shift, in which the accuracy of the determined frequency is increased by determining barycentric frequency areas both in the power spectrum of the transmitted signal and in the power spectrum of the received signal. In this case, the barycentric areas in the power spectrum of the received signal are adapted on the basis of a provisional Doppler frequency shift until the determined Doppler frequency shift converges. The Doppler frequency shift is determined on the basis of a multiplicity of frequency lines and multiplicity of associated barycentric frequency areas, as a result of which more accurate values than in the case of correlation of the two power spectra can be achieved by suitable weighting and averaging. Overall, the invention is based on the problem of improving the measurement accuracy of determination of the Doppler frequency shift, in particular for received signals and/or transmitted signals with a very short signal duration.

### SUMMARY OF THE INVENTION

The present invention solves the above identified problem for determination of a Doppler frequency shift resulting from the Doppler effect by the method according to Claim 1, as well as with an apparatus according to Claim 12 and a computer program according to Claim 15. For this purpose, the method according to the invention carries out a plurality of predetermined, relative frequency shifts, in each case by a real frequency shift value, between the transmitted signal and the received signal.

Either at least one shifted discrete amplitude spectrum of the transmitted signal and at least one shifted discrete amplitude spectrum of the received signal are produced, or a plurality of shifted discrete amplitude spectra of the transmitted signal are produced on their own, or a plurality of shifted discrete amplitude spectra of the received signal are produced on their own. The real frequency shift values which are theoretically possible for shifting are in this case not restricted to the frequency resolution or a multiple of the frequency resolution of the discrete amplitude spectrum of the transmitted signal or of the received signal. The real frequency shift values which are theoretically possible for shifting may in fact correspond to both fractions and to real multiples of the frequency resolution.

Furthermore, the quality of a match between the transmitted signal and the received signal, which are shifted relative to one another by the respective real frequency shift value, is in each case determined. The quality of this match is associated as a quality measure with the respective real frequency shift value by which the transmitted signal and the received signal have been shifted relative to one another. Furthermore, that quality measure is determined from the plurality of quality measures which corresponds to the highest quality of the match. The frequency shift value associated with this determined quality measure is then equated to the Doppler frequency shift to be determined and resulting from the Doppler effect.

Since such determination of the match is based not only on a frequency but on the entire amplitude spectrum of the received signal, a more accurate frequency shift is determined than by using conventional methods, in particular when the received signal is noisy.

Furthermore, the invention solves the abovementioned problem by means of an apparatus which has a spectrum generator module, a quality determination module and a selection module.

The spectrum generator module is designed to carry out a plurality of relative frequency shifts. These relative frequency shifts are each frequency shifts between the transmitted signal and the received signal, to be precise each by a real frequency shift value. Furthermore, for this purpose, the spectrum generator module is designed to produce at least one shifted discrete amplitude spectrum of the transmitted signal and at least one shifted discrete amplitude spectrum of the received signal. Furthermore, the spectrum generator module is designed to produce a plurality of shifted discrete amplitude spectra of the transmitted signal, or a plurality of shifted discrete amplitude spectra of the received signal.

The quality determination module is designed to in each case determine a quality of a match between the transmitted signal and the received signal, with the signals being shifted relative to one another by the respective real frequency shift value. The quality of this match is associated as a quality measure with the respective frequency shift value which is associated with the relative shift between the transmitted signal and the received signal.

Furthermore, the quality determination module contains the selection module, which is designed to determine that quality measure from the plurality of quality measures which corresponds to the highest quality of the match, with the frequency shift value associated with this determined quality measure being equated to the Doppler frequency shift to be determined and resulting from the Doppler effect.

In one preferred embodiment of the invention, the discrete amplitude spectrum of the transmitted signal and/or the discrete amplitude spectrum of the received signal are/is produced by means of frequency transformation from the corresponding signals in the time domain. This is done in particular by means of a discrete Fourier transformation (DFT) or by means of a fast Fourier transformation (FFT), with the respective frequency transformations having the same frequency resolutions, which can advantageously be defined in advance.

The Fourier transformation makes use of time windows of a finite length which—if the window length does not correspond exactly to the period duration of the frequency contained in the signal—lead to the so-called leakage effect. This leakage effect is advantageously utilized to carry out a pattern comparison between the amplitude spectra of the transmitted signal and of the received signal. Because of the use of a very large number of frequency lines, which are present in the amplitude spectrum because of the leakage effect, a method such as this for determination of the Doppler frequency shift is less susceptible to noise.

In a further preferred embodiment of the invention, the quality of the match between the transmitted signal and the received signal is determined by means of a pattern comparison, with the transmitted signal and the received signal being shifted relative to one another by the respective frequency shift value. The amplitude spectrum of the transmitted signal and the amplitude spectrum of the received signal are used for the pattern comparison in the frequency domain. This results in the advantage that the pattern comparison produces an associated quality measure, thus allowing the comparison to be assessed qualitatively.

According to a further embodiment of the invention, the pattern comparison is carried out by means of a statistical analysis method, in particular linear regression. The linear regression advantageously in each case produces a value for the gradient of the regression lines, the Y offset and the standard deviation, in order to determine a quality measure of the comparison.

In a further embodiment of the invention, the quality of the match between the transmitted signal and the received signal, which have been shifted relative to one another by the respective frequency shift value, is determined by means of convolution in the time domain. In this case, one convoluted signal is in each case produced from the transmitted and received signals which have been shifted relative to one another. This convoluted signal that is produced is transformed to the frequency domain. The magnitude of the transformed signal at the level of the maximum amplitude is associated with the quality measure.

In a further preferred embodiment of the invention, the possible real frequency shift value is subdivided into two frequency shift values which can be determined successively. A first frequency shift value, referred to in the following text as a coarse value, corresponds to the frequency resolution or to an integer multiple of the frequency resolution. A second frequency shift value, referred to in the following text as a fine value, corresponds to a fraction of the coarse value between −1 and 1. Subdivision of the real frequency shift value into an integer coarse value and a non-integer fine value makes it possible to speed up a search for the “optimum” frequency shift value, and to advantageously save computation power.

In a further embodiment of the invention, a quality measure which can be associated with the coarse value or the fine value is determined by means of the quality of the match between the transmitted signal and the received signal, which have been shifted relative to one another by the respective frequency shift value, by convolution of these shifted signals or by pattern comparison between these shifted signals. Since the quality measures can be determined both in the time domain and the frequency domain, this results in the advantages of rapid processing in the time domain and the use of structures which exist in the frequency domain.

According to a further embodiment of the invention a quality measure which is associated with the fine value is determined by means of the quality of the match between an amplitude spectrum, shifted by the coarse value, of the received signal and an amplitude spectrum, shifted by this fine value, of the transmitted signal in the frequency domain. Preferably, the received signal is shifted by the coarse value, and the quality measure associated with the fine value is determined by pattern comparison between the transmitted signal, which has been changed by the fine value, and the received signal which has been shifted by the coarse value. Since the received signal is shifted by the coarse value only once, this advantageously minimizes computation operations.

In a further embodiment of the invention, the discrete amplitude spectrum, shifted by a frequency shift value, of the transmitted signal or of the received signal is produced on the basis of its discrete amplitude spectrum. For this purpose, a plurality of interpolants are produced, which are each separated from one another by the frequency resolution, in particular by means of linear, polynomial or trigonometric interpolation. The interpolants are in this case formed as (new) amplitude values in the amplitude spectrum at (new) frequency values which have previously been discretely undefined, and are determined from two or more amplitudes which are associated with frequency values adjacent to the previously discretely undefined (new) frequency value. A frequency increase such as this by interpolation of existing discrete values can be carried out for the transmitted signal and/or the received signal and advantageously requires no information whatsoever relating to the theoretical amplitude response of the signal.

In a further preferred embodiment of the invention, the discrete amplitude spectrum, shifted by a frequency shift value, of the transmitted signal is produced on the basis of its amplitude frequency response. For this purpose, the discrete amplitude spectrum, shifted by the frequency shift value, of the transmitted signal, is determined numerically, analytically and/or graphically from this amplitude frequency response of the transmitted signal. The amplitudes of this determined amplitude spectrum are in each case separated by the frequency resolution. A frequency increase such as this by interpolation of the theoretical amplitude response of the transmitted signal can be carried out only for the transmitted signal, and is dependent on its theoretical amplitude response. This therefore advantageously allows the frequency resolution to be increased exactly, and theoretically in an unlimited manner.

According to a further embodiment of the invention, a velocity is determined as a function of wave transmission characteristics in a medium, in particular water, from the Doppler frequency shift. Furthermore, this determined velocity is assessed qualitatively by means of the quality measure which is associated with this Doppler frequency shift. This advantageously allows a weighted and quality-assessed velocity, which indicates the measurement accuracy of the method, to be determined from a plurality of processes carried out with a plurality of quality-assessing velocities.

In a further preferred embodiment of the invention, the apparatus mentioned above for determination of a Doppler frequency shift resulting from the Doppler effect comprises the transmitting arrangement and the receiving arrangement, which can be fitted underwater to a watercraft, and are designed respectively to transmit and receive hydroacoustic waves. An apparatus such as this advantageously corresponds to a sonar system, by means of which velocities underwater can be determined.

As an alternative to this, a further embodiment of the invention has the transmitting and receiving arrangement which are designed respectively to transmit and receive electromagnetic waves. An apparatus designed in this way corresponds to a radar system and has the advantage of determination of velocities of objects, such as aircraft, motor vehicles, etc., above water.

An alternative embodiment of the invention relates to a computer program, in particular to a computer program product, which has program code means for carrying out the method according to the invention when the program is run on a computer or an appropriate computation unit. The program code means can be stored on computer-legible data storage media, which may be suitable data storage media, such as floppy disks, hard disks, flash memory, EProms, CDs, DVDs or others. A program can also be downloaded via computer networks, in particular the Internet, Intranet, etc.

Further advantageous embodiments of the invention will become evident from the dependent claims and from the exemplary embodiments, which are explained in more detail with reference to the drawing.

### BRIEF DESCRIPTION OF THE DRAWINGS

FIG. 1 is a schematic illustration of a method process corresponding to the method according to the invention.

FIGS. 2A and 2B are simplified illustrations of the transmitted signal, in the time domain and in the frequency domain.

FIG. 3 is a schematic illustration of the functional process of the quality determination module.

FIG. 4 is a simplified illustration of the amplitude spectrum of the transmitted signal, as well as the shifted amplitude spectrum of the received signal.

FIG. 5 is a simplified illustration of the results of linear regression.

FIG. 6 is a simplified illustration of the intermediate values of the amplitude spectrum of the transmitted signal.

FIG. 7 is a simplified illustration of the amplitude spectrum, shifted by the fine value, of the transmitted signal.

### DETAILED DESCRIPTION OF THE INVENTION

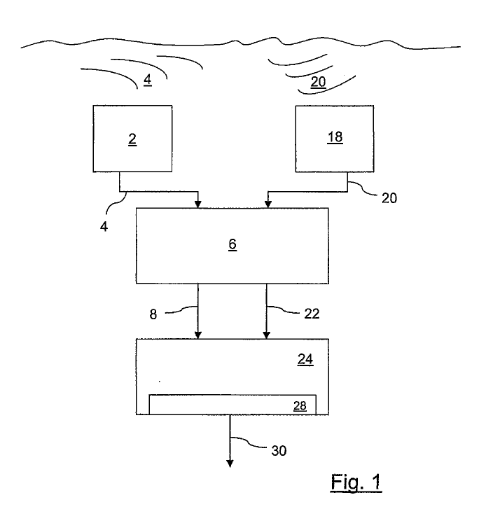

FIG. 1 shows a schematic illustration of the method process of one exemplary embodiment of the method according to the invention. In this case, first of all, a transmitting arrangement 2 transmits a transmitted signal 4 at a specific, constant frequency, and with a short pulse duration.

In the following text, the transmitting arrangement 2 is an arrangement which is arranged underwater on a watercraft and is designed to transmit hydroacoustic waves. Continuous-wave signals are preferably used as hydroacoustic waves, and are transmitted as the transmitted signal 4. However, it is also possible to use other transmitted signals 4 which are at a constant, known frequency. If the transmitted signal 4 contains more than one constant frequency then, however, these frequencies have to be further away from one another than the maximum Doppler frequency shift to be determined.

In one alternative refinement of the invention, the transmitting arrangement 2 is designed to transmit electroacoustic waves, and therefore forms a radar system.

An associated discrete amplitude spectrum 8 is determined from the known transmitted signal 4, by means of frequency transformation within a spectrum generator module 6.

The following explanatory notes relate to fast Fourier transformation (FFT) as the frequency transformation used. Further discrete transformations are likewise possible, provided that they produce the so-called leakage effect during signal analysis.

Because of the short pulse of the transmitted signal 4, the amplitude spectrum 8 does not consist of one line, but has a substantial width.

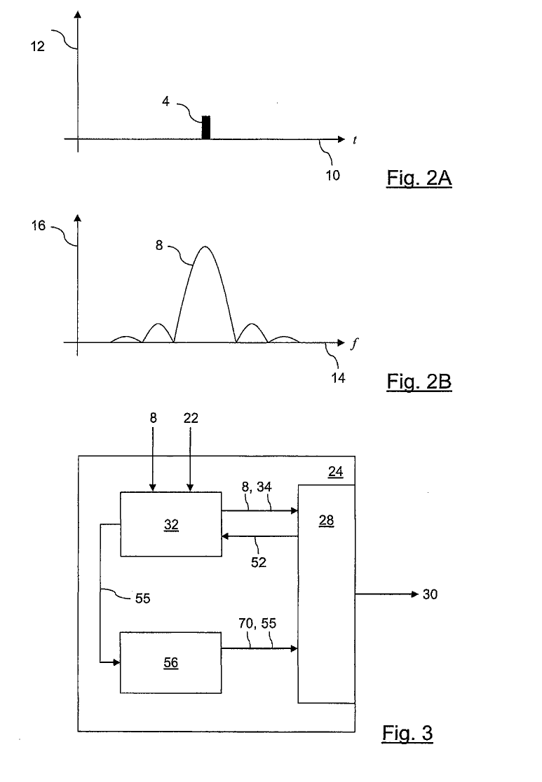

FIGS. 2A and 2B are simplified illustrations of the amplitude spectrum 8 of the transmitted signal 4.

FIG. 2A shows an illustration of the transmitted signal 4 in the time domain. In this illustration, the time t is plotted on a horizontal axis 10, and the amplitude of the transmitted signal 4 is plotted on a vertical axis 12. This is a short-duration pulsed signal.

FIG. 2B shows an illustration of the amplitude spectrum 8 of the transmitted signal 4 in the frequency domain. For this purpose, the frequency f is plotted on a horizontal axis 14, and the amplitudes of the amplitude spectrum 8 are plotted on a vertical axis 16.

FIGS. 2A-2B illustrate the so-called leakage effect, as can occur when using frequency transformation. The amplitude spectrum 8 does not consist of one frequency line but has a substantial width. This results from the time-limiting of the transmitted signal 4 by means of a square-wave function. This leads to the signal 4 being chopped off and for the capability to carry out Fourier transformation only if it can be continued periodically. If the window length is not actually an integer multiple of the period of the signal 4, the leakage effect occurs, and the calculated amplitude spectrum 8 is “smeared”. Since the spectrum of the window function is a critical factor for the leakage, this results in a sin x/x profile such as this, as shown in FIG. 2B.

The invention has identified that the leakage effect can be utilized advantageously. Instead of a single spectral line, other frequencies also exist in the amplitude spectrum 8, as well as the main frequency. A pattern comparison further in the method process can therefore be based on more than just one spectral line.

Corresponding to the method process shown in FIG. 1, a received signal 20 which is received by a receiving arrangement 18 is transferred to the spectrum generator module 6. In the following text, the receiving arrangement 18 is an arrangement which is arranged underwater on a watercraft and is designed to receive hydroacoustic waves. However, the invention is not restricted to a receiving arrangement 18 underwater. In one alternative refinement of the invention, the receiving arrangement 18 is designed to receive electroacoustic waves, and therefore forms a radar system.

Within the spectrum generator module 6, an associated amplitude spectrum 22 is determined from the received signal 20 by means of frequency transformation, with the sampling frequency and the FFT length corresponding to those of the amplitude spectrum 8 of the transmitted signal 4. This amplitude spectrum 22 corresponds approximately to the amplitude spectrum 8 of the transmitted signal 4, but is noisy in the present case, and has been frequency-shifted relative to the transmitted signal 4, because of the Doppler effect.

The amplitude spectrum 8 of the transmitted signal 4 and the amplitude spectrum 22 of the received signal 20 are both transferred to a quality determination module 24 in a further processing step. Here, a plurality of relative frequency shifts are carried out between the transmitted signal and the received signal 20, in each case by a theoretically possible, real frequency shift value.

With the intention of associating a quality measure with the respectively used frequency shift value, a pattern comparison is carried out in the quality determination module 24 in order to determine the quality of the match between the transmitted signal 4 and the received signal 20, which have been shifted relative to one another, and to indicate this by means of an appropriate quality measure, with the quality measure being associated with the respective frequency shift value by which the transmitted signal 4 and the received signal 20 have been shifted relative to one another.

The quality measures determined in the quality determination module 24 are transferred together with the associated real frequency shift values used to a selection module 28, which uses them to determine that quality measure which corresponds to the highest quality of the match between the relatively shifted transmitted signal 4 and received signal 20. The real frequency shift value which is associated with this quality measure is equated to the Doppler frequency shift 30 to be determined, and is output.

FIG. 3 shows a schematic illustration to explain the operation of the quality determination module 24 on the basis of one exemplary embodiment of the invention. The amplitude spectra 8, 22 which are present are transferred to the quality determination module 24. In doing so, the amplitude spectrum 22 of the received signal 20 has to be recalculated for each method run, while the amplitude spectrum 8 of the transmitted signal 4 can be stored in the system for a plurality of method runs, provided that the transmitted signal 4 does not change.

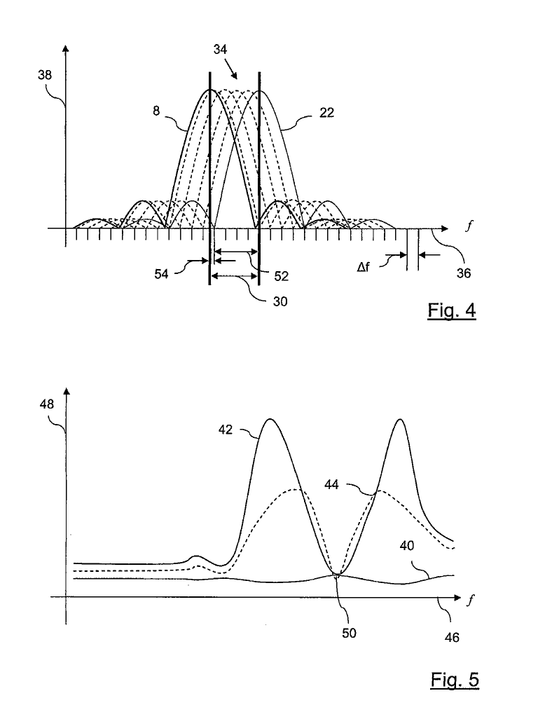

The amplitude spectrum 22 of the received signal 20 is shifted using a coarse shift module 32, as illustrated in FIG. 4.

FIG. 4 shows a simplified illustration of the amplitude spectrum 8 of the transmitted signal 4, using the same coordinate system as the amplitude spectrum 22 of the received signal 20, together with a plurality of shifted amplitude spectra 34. In the coordinate system, the frequency f is indicated on a horizontal axis 36, and the amplitude of the amplitude spectra is indicated on a vertical axis 38.

The amplitude spectrum 22 of the received signal 20 is in each case shifted by a frequency step Δf until the amplitude spectrum 22 matches the amplitude spectrum 8 of the transmitted signal 4 as well as possible.

The frequency step Δf is in this case the ratio of the sampling frequency and the FFT length of the amplitude spectrum 22, which indicates the frequency resolution and corresponds to the frequency shift value. However, it is likewise feasible to define a multiple of this frequency resolution as the frequency step Δf and as the frequency shift value.

A pattern comparison is carried out for each shift by a possible frequency shift value, in order to determine the best possible match between the amplitude spectrum 8 and the amplitude spectrum 22. As shown in FIG. 3, this pattern comparison is carried out in the selection module 28. For this purpose, the amplitude spectrum 8 of the transmitted signal 4 and the plurality of the shifted amplitude spectra 34 are transferred to the selection module 28. If the pattern comparison is carried out by linear regression, then a standard deviation is calculated for each shifted amplitude spectra 34. The standard deviation corresponds to the quality measure to be determined, and is associated with the frequency shift value applied to the respective shift.

However, the invention is not restricted to the linear regression for carrying out the pattern comparison. In alternative embodiments, correlation can be carried out, for example, as an analysis method.

FIG. 5 shows an illustration of the results of one possible linear regression. The graph shows both the gradient 40 of the regression lines, the Y offset 42 and the standard deviation 44, in each case plotted on a horizontal axis 46 for the frequency f, and a vertical axis 48 in order to illustrate the amplitude.

That frequency shift value which corresponds to the best possible match between the transmitted signal 4 and the received signal 20, which have been shifted relative to one another, is located on the horizontal axis 46 at that point 50 at which the standard deviation 44, as a function, reaches its minimum. The frequency shift value associated with this point 50 is transferred as the so-called coarse value 52 to the coarse shift module 32.

In one alternative method variant of the determination of the coarse value 52 as described above, the determination of the coarse value 52 is not restricted to shifting the amplitude spectrum 22 of the received signal 20. Since the method according to the invention is based on relative frequency shifts between the transmitted signal 4 and the received signal 20, it is likewise alternatively possible to shift the amplitude spectrum 8 of the transmitted signal 4 by corresponding frequency steps Δf or frequency shift values.

The coarse value 52 is equal to the frequency resolution or to an integer multiple of the frequency resolution. The accuracy of the best-possible match between the amplitude spectra 8 and 22 is, however, predetermined by the frequency resolution. The actual Doppler frequency shift 30 to be determined between the transmitted signal 4 and the received signal 20 may, however, be a fraction of the frequency resolution or a multiple of a fraction of the frequency resolution. A fine value 54, which, as shown in FIG. 4, together with the coarse value 52, produces the Doppler frequency shift 30 must therefore also be determined in order to determine the Doppler frequency shift 30.

In order to determine the fine value 54, the coarse value 52 as previously determined in the selection module 28 is first transferred to the coarse shift module 32, as shown in FIG. 3.

In order to determine a shifted amplitude spectrum 55, the determined amplitude spectrum 22 of the received signal 20 is shifted by the previously determined coarse value 52 in the coarse shift module 32, such that only a shift which amounts to a fraction of the frequency resolution or frequency step Δf is now still present between the amplitude spectra 8 and 55. The amplitude spectrum 55 which has been shifted in this way is then transferred to a fine shift module 56.

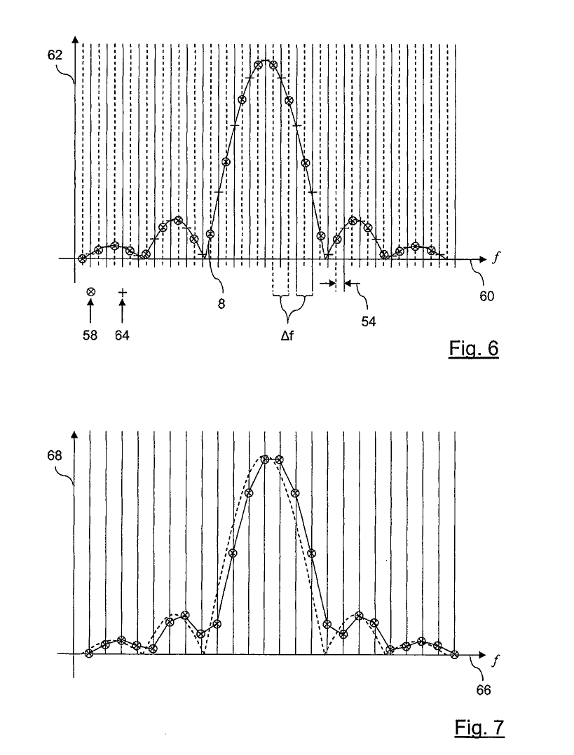

In order to increase the frequency resolution for determination of an accurate Doppler frequency shift, intermediate values 58 for the known amplitude spectrum 8 of the transmitted signal 4 are calculated in the fine shift module 56, as shown in FIG. 6.

FIG. 6 shows an illustration of the intermediate values 58 of the amplitude spectrum 8 of the transmitted signal 4, with the frequency f being illustrated on a horizontal axis 60, and the amplitude of the amplitude spectrum 8 being illustrated on a vertical axis 62.

Since the transmitted signal 4 is known, any desired number of further intermediate values 58 can in theory be calculated, in addition to the values 64 of the amplitude spectrum 8 as determined by means of the FFT. This makes it possible to increase the frequency resolution of the amplitude spectrum 8 indefinitely, in the end leading to an increase in the accuracy of the determination of the Doppler frequency shift 30. In this case, the intermediate values 58 are mathematically determined using analytical or computational methods, and are yet again separated from one another by the frequency step Δf or the frequency resolution. This is necessary in order to allow the subsequent pattern comparison to be carried out. The separation between the intermediate value 58 and an FFT value 64 which is separated from it then corresponds to the fine value 54. The amplitude spectrum 8 is then shifted by the fine value 54 determined in this way.

FIG. 7 shows an illustration of the amplitude spectrum 8, shifted by the fine value 54, of the transmitted signal 4. A dashed line indicates the original amplitude spectrum 8, and a solid line indicates the shifted or recalculated amplitude spectrum. The horizontal axis 66 contains the frequency values f, and the vertical axis 68 contains the amplitude values.

However, the invention is not restricted to determination of the intermediate values 58 on the basis of the amplitude spectrum 8 of the transmitted signal 4. In alternative embodiments, the amplitude spectrum 22 of the received signal 20 is used to determine the intermediate values 58. The intermediate values 58 are, however, subject to errors because of the noisy received signal 20, and can be calculated only by means of interpolation.

A plurality of fine values 54 are determined in this way, for which a plurality of shifted amplitude spectra 70 are calculated, which are transferred to the selection module 28 together with the shifted amplitude spectrum 55, using the method illustrated in FIG. 3.

A pattern comparison is once again carried out in the selection module 28. The amplitude spectrum 55, shifted by the coarse value, of the received signal 20 is compared with the plurality of amplitude spectra 70 shifted by fine values 54, and linear regression is used to determine the quality measure which indicates that of the shifted amplitude spectra 70 which best matches the amplitude spectrum 55.

The fine value 54 associated with this quality measure, together with the previously determined coarse value 52, results in the sought Doppler frequency shift 30, which is output in order to determine, for example, a velocity of the watercraft.

An overall quality measure can be indicated from the quality measure associated with the coarse value 52 and the quality measure associated with the fine value 54, providing a qualitative assessment of the subsequent calculation of the velocity.

In an alternative refinement of the invention, the quality of the match between the transmitted signal 4 and the received signal 20, which have been shifted relative to one another, is determined by convolution in the time domain. For this purpose, a convolved signal is in each case produced from the respective transmitted signal 4 and received signal 20, which have been shifted by the frequency shift value relative to one another. The convolved signal produced in this way is then transformed to the frequency domain, and has a magnitude at its maximum amplitude which corresponds to the quality measure.

The method described above can be modified in such a way that the real frequency shift value is not subdivided into a coarse value and a fine value.

The method as shown in FIG. 3 then has only a fine shift module 56. The fine value 54 to be determined in the fine shift module 56 then, however, comprises not only a fraction of the frequency resolution, but also a multiple of the fraction of the frequency resolution, and therefore assumes an arbitrary real value.

In this method variant, the transmitted signal or the received signal is optionally shifted by a real frequency shift value in order to determine the Doppler frequency shift, resulting from the Doppler effect, between the transmitted signal 4 and the received signal 20.

In this case, analogously, the method of operation of the selection module 28 corresponds to the exemplary embodiment described above.

All of the features mentioned in the above description of the figures, in the claims and in the introductory part of the description can be used both individually and in any desired combination with one another. The disclosure of the invention is therefore not limited to the described and/or claimed feature combinations. In fact, all feature combinations should be considered as being disclosed.

1. Method for determination of a Doppler frequency shift (30), resulting from the Doppler effect, between a transmitted signal (4) and a received signal (20) which results from this transmitted signal (4),
comprising the following steps:
a) a plurality of relative frequency shifts are carried out, in each case by a real frequency shift value, between the transmitted signal (4) and the received signal (20), in that
i) at least one shifted discrete amplitude spectrum (8) of the transmitted signal (4) and at least one shifted discrete amplitude spectrum (22) of the received signal (20) are produced, or
ii) a plurality of shifted discrete amplitude spectra of the transmitted signal (4) are produced, or
iii) a plurality of shifted discrete amplitude spectra of the received signal (20) are produced,
and with the real frequency shift value corresponding to a fraction or a real multiple of the frequency resolution of the discrete amplitude spectrum of the transmitted signal or of the received signal.
b) a quality of a match between the transmitted signal (4) and the received signal (20), which have been shifted relative to one another by the respective real frequency shift value, is in each case determined, with the quality of this match being associated as a quality measure with the respective real frequency shift value,
c) that quality measure is determined from the plurality of quality measures which corresponds to the highest quality of the match, with the real frequency shift value associated with this determined quality measure being equated to the Doppler frequency shift (30) to be determined and resulting from the Doppler effect.

2. Method according to claim 1,
wherein
the discrete amplitude spectrum (8) of the transmitted signal (4) and/or the discrete amplitude spectrum (22) of the received signal (20) are/is produced by means of frequency transformation, in particular by means of a discrete Fourier transformation (DFT) or by means of a fast Fourier transformation (FFT) from its signal in the time domain, in particular incorrectly because of the leakage effect, with the frequency transformation in each case leading to the same frequency resolution.

3. Method according to claim 1,
wherein
the quality of the match between the transmitted signal (4) and the received signal (20), which have been shifted relative to one another by the respective frequency shift value, subsequently referred to as the shifted signal pair, is determined by means of a pattern comparison of their amplitude spectra in the frequency domain.

4. Method according to claim 3,
wherein
the pattern comparison between the amplitude spectra of the respective shifted signal pair is carried out in the frequency domain by means of linear regression, with the standard deviation of the pattern comparison being equal to the quality measure.

5. Method according to claim 1,
wherein
the quality of the match between the transmitted signal (4) and the received signal (20), which have been shifted relative to one another by the respective possible frequency shift value, is determined by means of convolution in the time domain, in that a convoluted signal is in each case produced from the respective transmitted signal (4) and received signal (20), shifted relative to one another by the respective frequency shift value, with the convoluted signal that is produced, transformed to the frequency domain, having a maximum amplitude magnitude which is equated to the quality measure.

6. Method according to claim 1,
wherein
the real frequency shift value is subdivided into two frequency shift values which can be determined successively, with a first frequency shift value, referred to in the following text as a coarse value (52), being equal to the frequency resolution or to an integer multiple of the frequency resolution, and with a second frequency shift value, referred to in the following text as a fine value (54), being equal to a fraction of the coarse value (52).

7. Method according to claim 6,
wherein
a quality measure which can be associated with the coarse value (52) or the fine value (54) is determined by means of the quality of the match between the shifted signal pair by convolution of the shifted signal pair or by pattern comparison between the shifted signal pair.

8. Method according to claim 6,
wherein
a quality measure which is associated with the fine value (54) is determined by means of the quality of the match between an amplitude spectrum (55), shifted by the coarse value (52), of the received signal (20) and an amplitude spectrum, shifted by this fine value (54), of the transmitted signal (4) in the frequency domain.

9. Method according to claim 1,
wherein
the discrete amplitude spectrum, shifted by a frequency shift value, of the transmitted signal (4) or of the received signal (20) is produced on the basis of its discrete amplitude spectrum in that a plurality of interpolants (58) are produced, which are each separated from one another by the frequency resolution, in particular by means of linear, polynomial or trigonometric interpolation, with the interpolants (58) being formed as (new) amplitude values in the amplitude spectrum at (new) frequency values which have previously been discretely undefined, and with these (new) amplitude values being determined from two or more amplitudes which are associated with frequency values adjacent to the previously discretely undefined (new) frequency value.

10. Method according to claim 1,
wherein
the discrete amplitude spectrum, shifted by a frequency shift value, of the transmitted signal (4) is produced on the basis of its amplitude frequency response, in that the discrete amplitude spectrum, shifted by the frequency shift value, of the transmitted signal (4), is determined numerically, analytically and/or graphically from this amplitude frequency response of the transmitted signal (4), and whose amplitudes of this determined amplitude spectrum are each separated by the frequency resolution.

11. Method according to claim 1,
wherein
a velocity is determined as a function of wave transmission characteristics in a medium, in particular in water, from the Doppler frequency shift (30), with this determined velocity being assessed qualitatively by means of the quality measure which is associated with this Doppler frequency shift (30).

12. Apparatus for determination of a Doppler frequency shift (30), resulting from the Doppler effect, between a transmitted signal (4) of a transmitting arrangement (2) and a received signal (20), which results from this transmitted signal (4), in a receiving arrangement (18), in particular for carrying out the method according to claim 1,
wherein
a) a spectrum generator module (6), which is designed to carry out a plurality of relative frequency shifts, in each case by a possible frequency shift value between the transmitted signal (4) and the received signal (20), in that
i) at least one shifted discrete amplitude spectrum (8) of the transmitted signal (4) and at least one shifted discrete amplitude spectrum (22) of the received signal (20) are produced, or
ii) a plurality of shifted discrete amplitude spectra of the transmitted signal (4) are produced, or
iii) a plurality of shifted discrete amplitude spectra of the received signal (20) are produced,
and with the real frequency shift value corresponding to a fraction or a real multiple of the frequency resolution of the discrete amplitude spectrum of the transmitted signal or of the received signal.
b) a quality determination module (24), which is designed to in each case determine a quality of a match between the transmitted signal (4) and the received signal (20), which have been shifted relative to one another by the respective possible frequency shift value, with the quality of this match being associated as a quality measure with the respective possible frequency shift value, and
c) a selection module (28), which is designed to determine that quality measure from the plurality of quality measures which corresponds to the highest quality of the match, with the possible frequency shift value associated with this determined quality measure being equated to the Doppler frequency shift (30) to be determined and resulting from the Doppler effect.

13. Apparatus according to claim 12,
wherein
the apparatus comprises the transmitting arrangement (2) and the receiving arrangement (18), and this transmitting arrangement (2) and this receiving arrangement (18) are arranged underwater on a watercraft and are designed respectively to transmit and receive hydroacoustic waves.

14. Apparatus according to claim 12,
wherein
the apparatus comprises the transmitting arrangement (2) and the receiving arrangement (18), and this transmitting arrangement (2) and this receiving arrangement (18) are designed respectively to transmit and receive electromagnetic waves.

15. Computer program, which has computer program code means which are suitable for carrying out the method according to claim 1 when the program is run on a computer.
